(19) United States
(12) Patent Application Publication
(10) Pub. No.: US 2014/0351164 A1
(43) Pub. Date: Nov. 27, 2014

(54) METHOD OF SEQUENCING A DELIVERY ROUTE

(71) Applicant: ANS Tech, LLC, Orion, MI (US)

(72) Inventors: Jerry Wayne Ballenger, Addison Twp., MI (US); Richard Alan Epstein, Aberdeen, NJ (US)

(73) Assignee: ANS Tech, LLC, Orion, MI (US)

(21) Appl. No.: 13/899,695

(22) Filed: May 22, 2013

(51) Int. Cl. G06Q 10/08; G01C 21/34

(52) U.S. Cl. CPC G06Q 10/08355; G01C 21/34
USPC 705/338

(57) ABSTRACT

A method for sequencing geo coded addresses on a delivery route with the use of a device is disclosed, The methodology includes the steps of a driver selecting a street segment on a device and selecting a sequence mode for the delivery. The methodology also includes driving down a selected street segment and confirming an odd or even number of the addresses on either side of the street. The methodology also comprises the marking of each address as delivered as it is passed by the driver.

### BACKGROUND OF THE INVENTION

1. Field of the Invention

The invention generally relates to delivering goods or packages to predetermined addresses, and more particularly relates to a methodology for sequencing and subsequently marking addresses as delivered on a predetermined route.

2. Description of Related Art

It is well known in the art to move subscription goods, such as magazines, periodicals, newspapers, and/or other goods to predetermined customers or locations by a vehicle and driver. Such vehicles provide multi-media companies with, the capability and flexibility to transport periodicals, newspapers, magazines, and/or other goods to multiple destinations in the most efficient manner.

Many individuals and businesses choose to subscribe to these periodicals, newspapers, magazines and/or other goods in the form of predetermined length subscriptions. Generally, these subscriptions may involve the regular mailing and/or delivery of the periodicals, newspapers, magazines and/or other goods to the individual's residence, place of business or any other designated location or place that the subscriber wishes to have the goods delivered to. Many of these periodicals, newspapers, magazines and/or other goods are also typically available at newsstands, in stores, or other places of business. Generally, the subscriber of these periodicals, newspapers, magazines and/or other goods may obtain a discount by having a subscription that is delivered to the home residence, or place of business and hence, having delivery of the periodicals, newspapers, magazines and/or other goods at the proper time is of utmost importance to most subscribers. Furthermore, the accurate and timely delivery of the goods being subscribed to at the individual's residence, place of business or other location are of utmost importance to the subscriber and the business providing such material. The confirmation of such delivery of the goods to a specific address also may be necessary to ensure proper customer satisfaction and to protect the business from unscrupulous subscribers trying to rip off a business in today's high paced business world.

Therefore, there is a need in the art for an efficient, method, and apparatus for confirming delivery of goods or materials to predetermined addresses in a subscription route. There also is a need in the art for a method and apparatus for photo confirmation of delivery to a specific address of periodicals, newspapers, magazines and/or other goods. Furthermore, there is a need in the art for a method and apparatus for sequencing and subsequently marking addresses as being delivered based, on the address and the side of the street the building is arranged. There also is a need in the art for a delivery method that interacts with the driver to enable data manipulation through specific instructions, times to deliver, verifying delivery, et al., and the movement of such data from the driver to a remote location to enable the business providing such goods or materials with real time data regarding delivery of such goods. There also is a need in the art for an improved geo coded methodology capable of efficiently providing delivery of packages to a segment of predetermined addresses.

### SUMMARY OF THE INVENTION

One object of the present invention may be to provide an improved method and apparatus for delivering goods to a specific address.

Another object of the present invention may be to provide an improved method and apparatus for sequencing and subsequently marking addresses as being delivered based on the addresses position and on which side of the street it is located.

Still another object of the present invention may be to provide a method of delivering that provides confirmation of delivery of goods at an address in real time.

Yet another object of the present invention may be to provide a method of delivering goods that allows the driver to select, a street segment on their device from a predetermined collection of advanced street segments preloaded with delivery data therein.

Still another object of the present invention, may be to provide a method for delivering goods that has each address geo coded with its GPS coordinates and marks the address as delivered when the driver passes by such addresses on the street segment selected.

Yet another object of the present invention may be to provide a method of delivering goods that allows data created by driving and running the sequencing to be manipulated to insert any changes into the addresses, delivery preferences or the like and uploading such delivery preferences to an external or remote system for further processing.

Still another object of the present invention may be to provide a method of delivering goods that is more efficient and accurate than, delivery methods of the prior art.

To achieve the foregoing objects and other advantages, a method and apparatus for delivering goods to specific geo coded addressees on a delivery route with the use of a device is disclosed. The method comprises the steps of a driver selecting a street segment on the device and then selecting a sequence mode for the delivery. The method further comprises the step of the driver driving down the selected street segment and confirming an odd or even number of the addresses and on which side of the street the addresses are located. The method also comprises the steps of marking each address as delivered as it is passed by the driver via the geo coding of the addresses and the device or vehicles position with relation to a proximity area. The methodology also comprises the capability of providing confirmation of delivery via a real time photo of the package delivered at the predetermined address.

One advantage of the present invention may be that it provides a novel and improved method of delivering goods to a specific address.

Still another advantage of the present invention may be that it provides a novel and improved method of delivering goods to predetermined addresses via the use of geo coding of addresses and a GPS capable device or vehicle.

Yet another advantage of the present invention may be that it provides a method of delivering goods to a predetermined address, which includes the sequencing and subsequent marking of the addresses as delivered based on the addresses being on a predetermined side of the street that the driver passes on the delivery route.

Still another advantage of the present invention may be that it provides a methodology that allows the driver to select a street segment on a device for delivery.

Still another advantage of the present invention may be that it provides a method of delivering goods that allows the driver to progress down a selected street and confirm the odd or even numbers of the houses to ensure the correct grouping of data and to ensure that each geo coded address as it is passed is being sequenced as being delivered.

Yet another advantage of the present invention may be that the driver is capable of manipulating the data after the driver has finished delivering on a selected route and then sending the data via uploading to a remote location for further processing.

Still another advantage of the present invention may be that it provides a methodology for delivering goods to a specific address that uses data created by driving and running sequenced routes and a manipulation of such data to ensure smoother and more efficient deliveries to the same selected segments at a future time.

Yet another advantage of the present invention may he that it provides for a method of delivering packages or goods to an address that is more efficient and reliable than those delivery methods of the prior art.

Other objects, features and advantages of the present invention may become apparent from the subsequent description and the appended claims, taken in conjunction with the accompanying drawings.

### BRIEF DESCRIPTION OF THE DRAWINGS

FIG. 1 is a flow chart of a methodology of delivering goods according to the present invention.

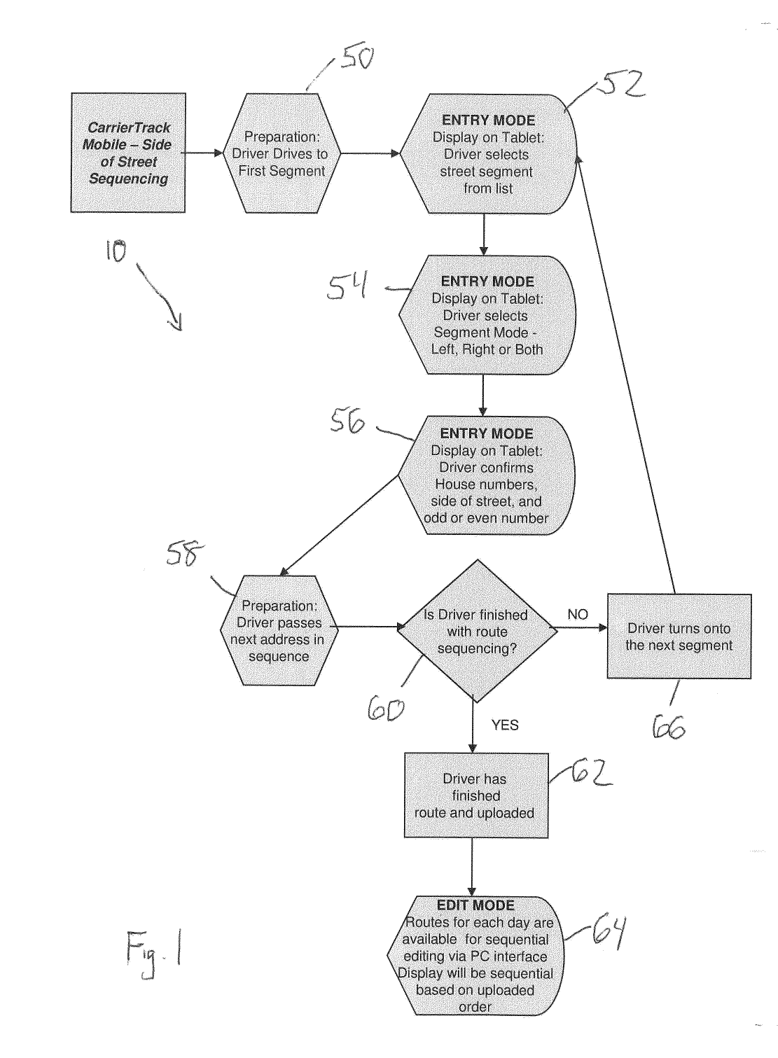

FIG. 2 is a screen shot of a device used with the methodology of the present invention.

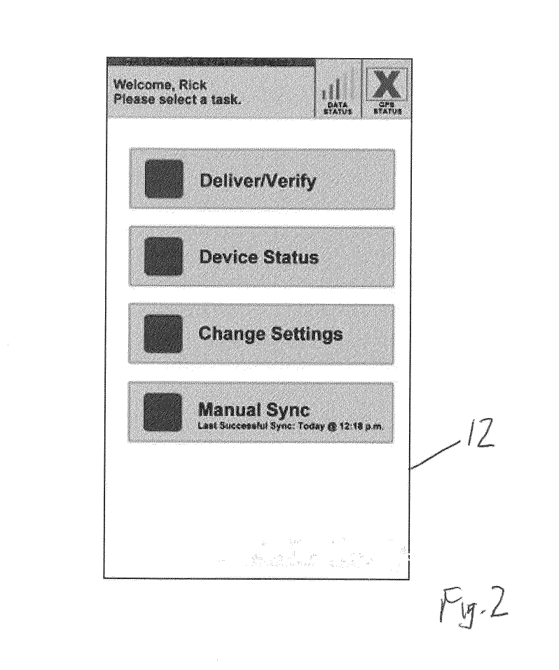

FIG. 3 is a screen shot of a device used with the methodology according to the present invention.

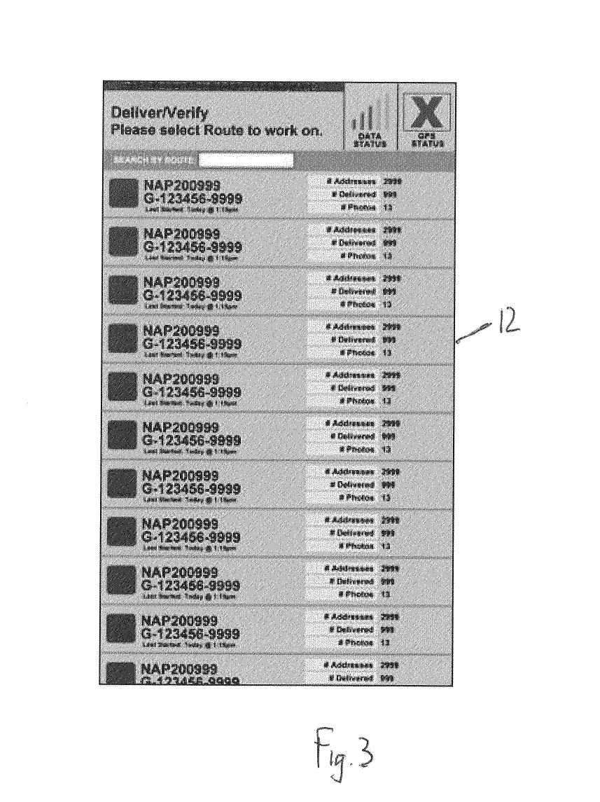

FIG. 4 is a screen shot of a device used with the methodology according to the present invention.

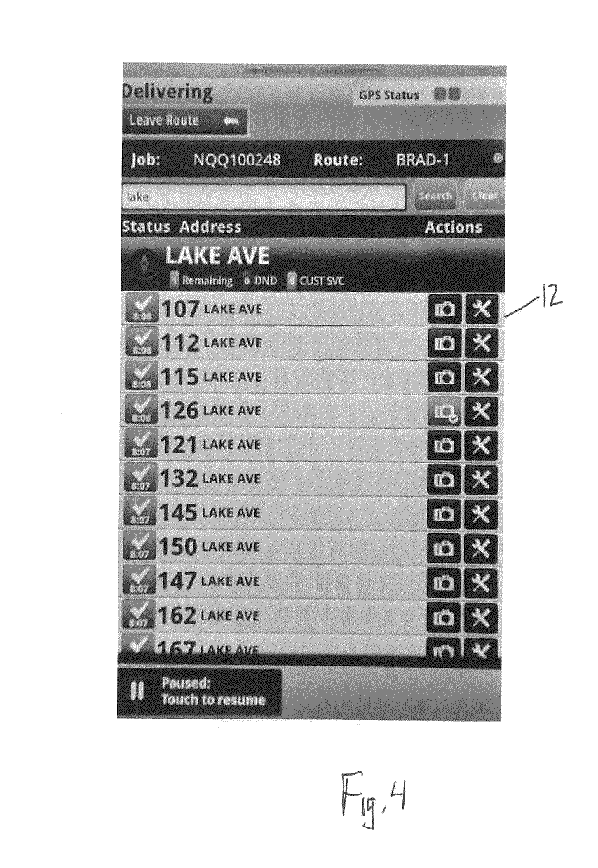

FIG. 5 shows a schematic view of a proximity area for use with the device in accordance with the methodology of the present invention.

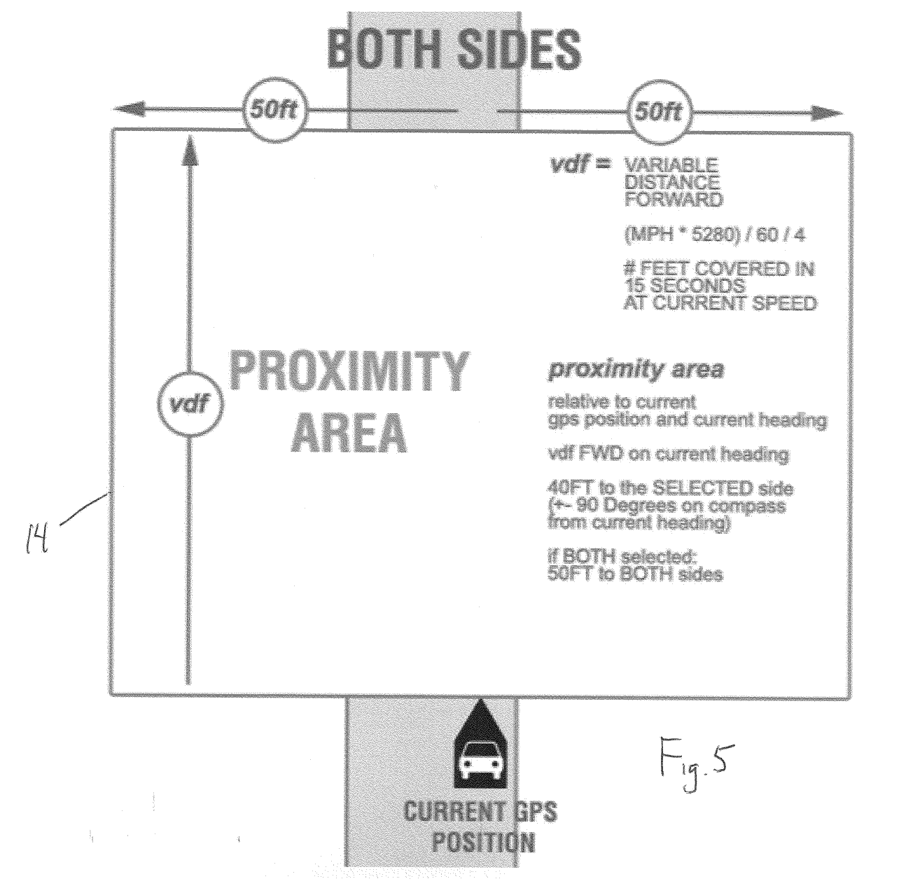

FIG. 6 shows a schematic view of a proximity area for use with the device in accordance with the methodology of the present invention.

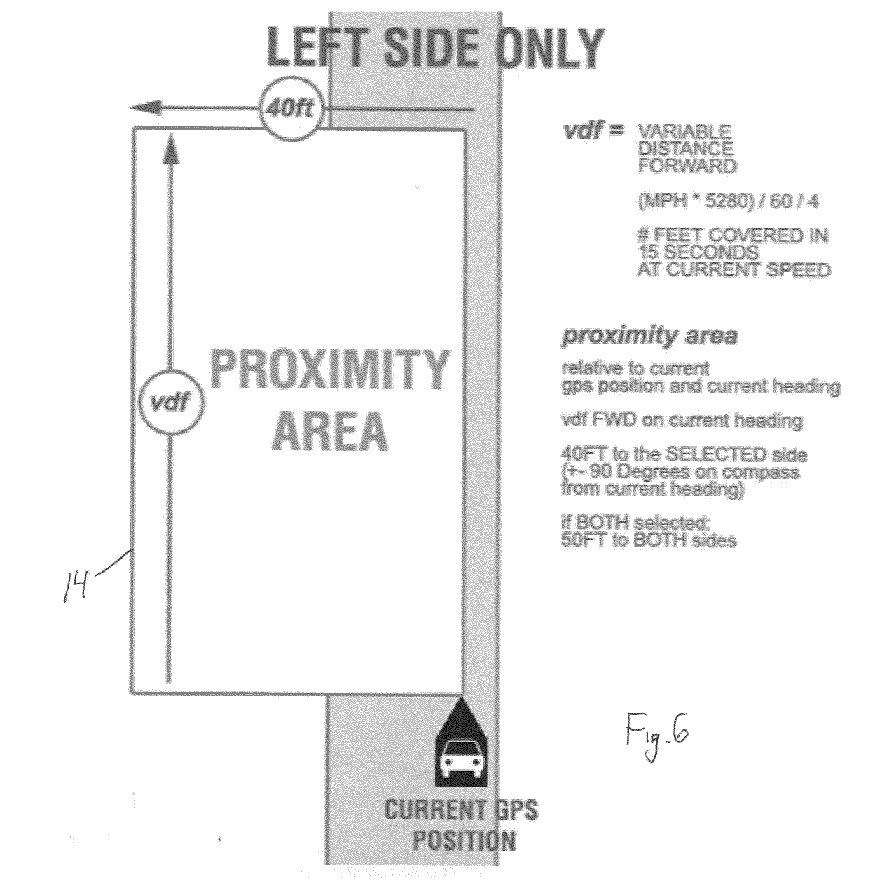

FIG. 7 shows a schematic view of a proximity area for use with a device of the

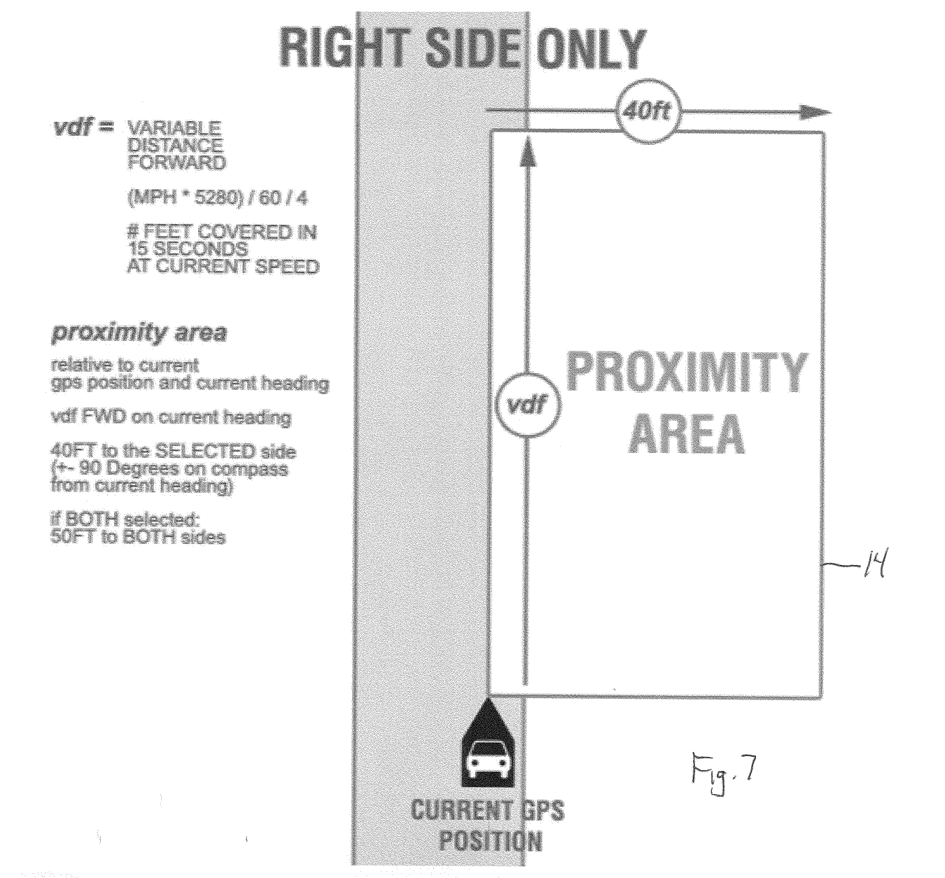

methodology of the present invention.

FIG. 8 is a screen shot, of a device used with the methodology according to the present invention.

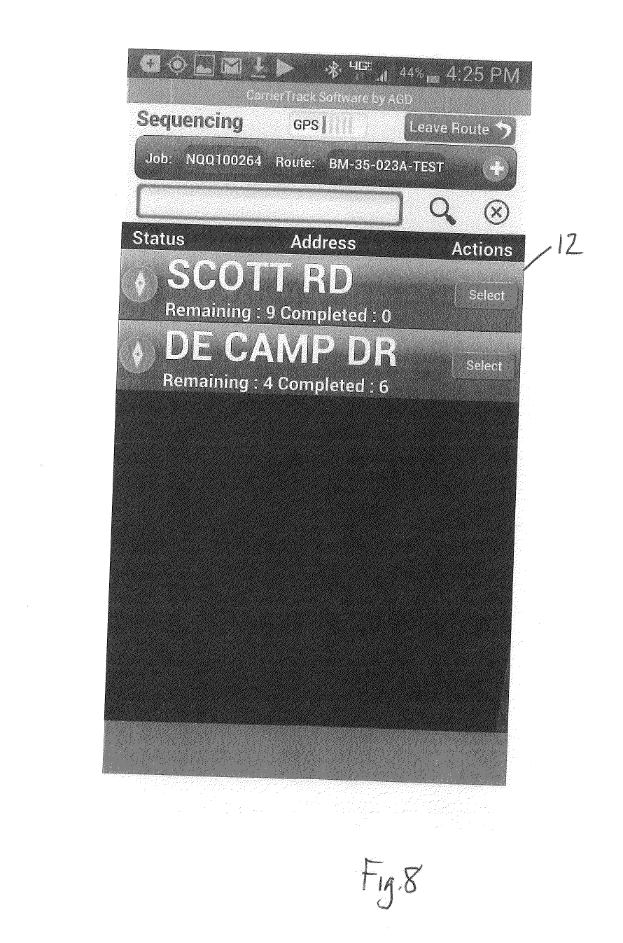

FIG. 9 is a screen shot of a device used with the methodology according to the present invention.

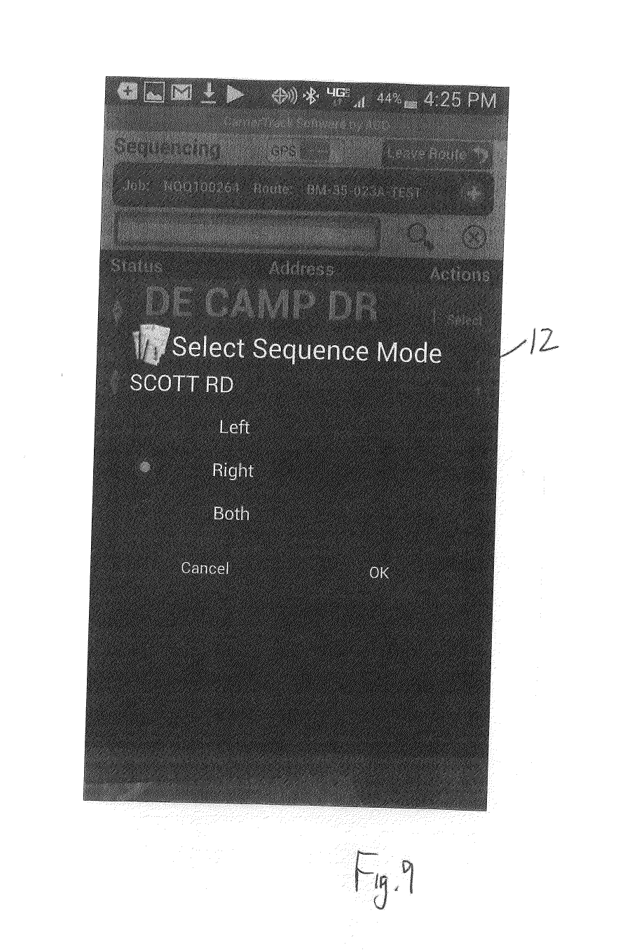

FIG. 10 is a screen shot of a device used with the methodology according to the present invention.

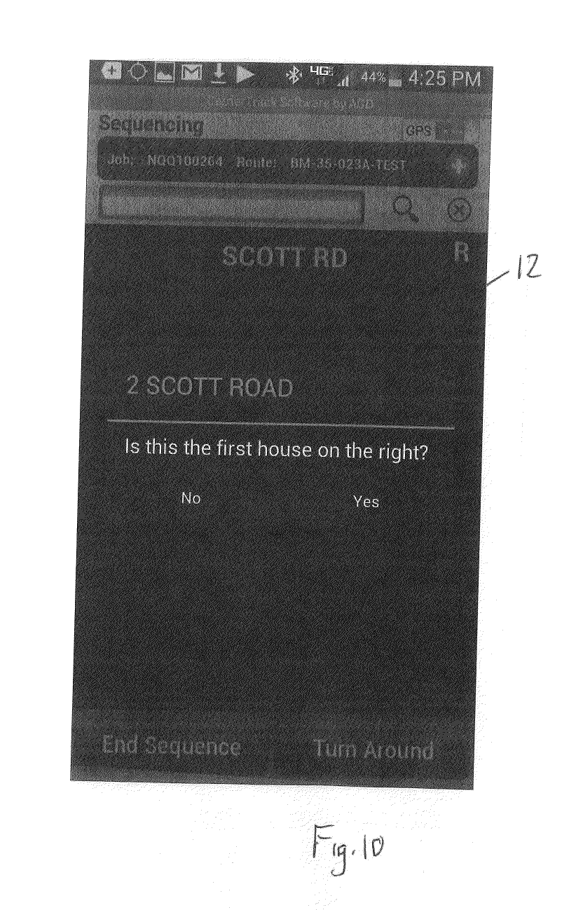

FIG. 11 is a screen shot of a device used with the methodology according to the present invention.

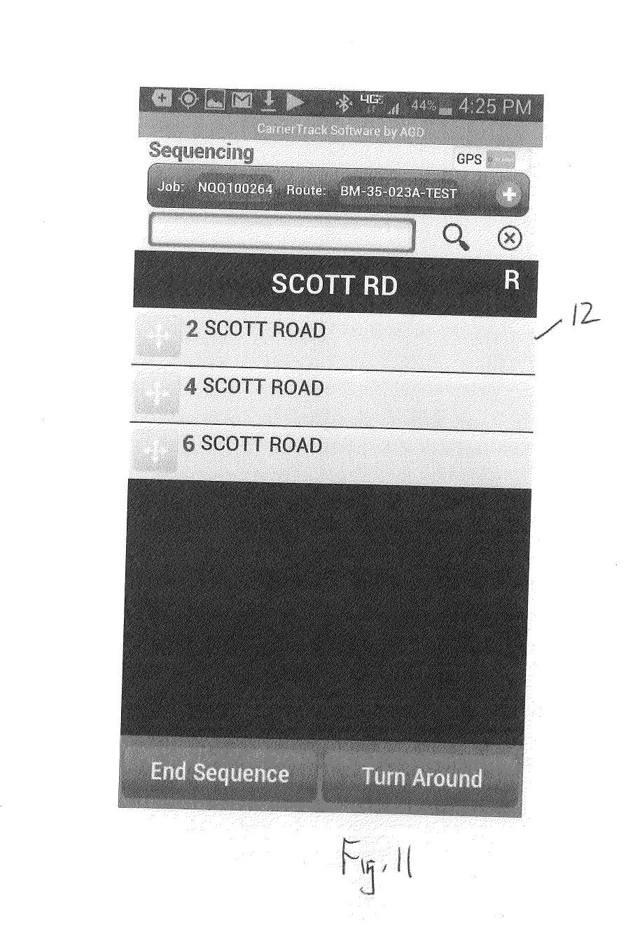

FIG. 12 is a screen shot of a device used with the methodology according to the present invention.

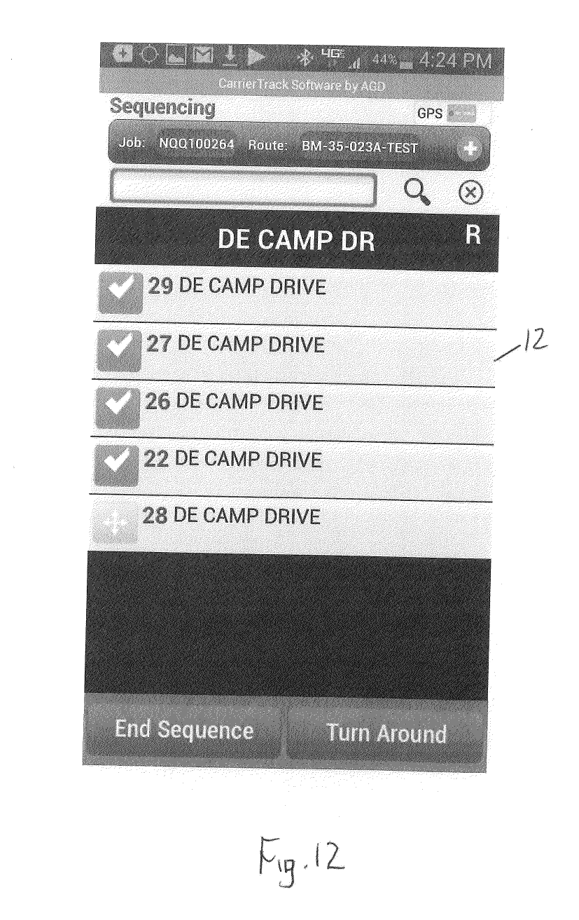

FIG. 13 is a screen shot of a device used with the methodology according to the present invention.

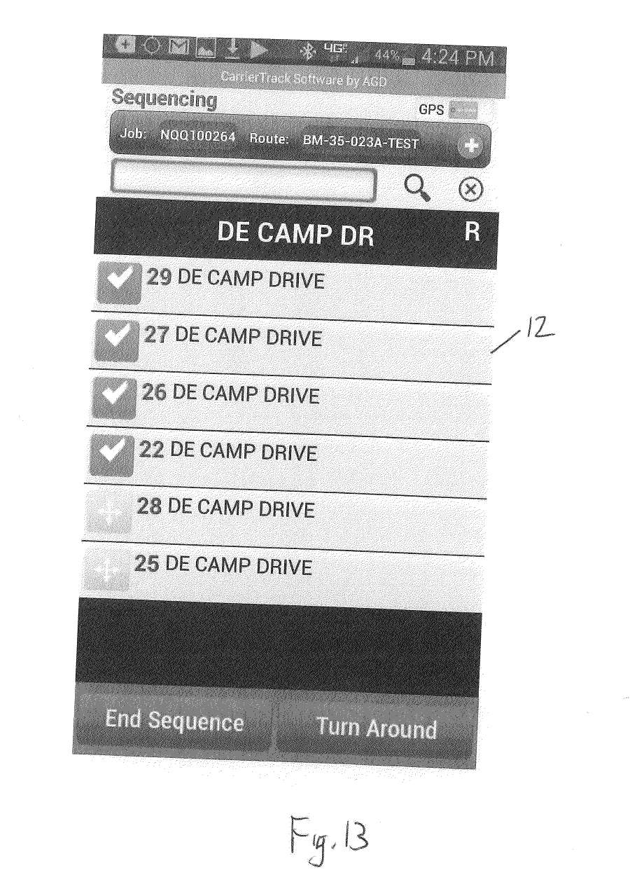

FIG. 14 is a screen shot of a device used with the methodology according to the present invention.

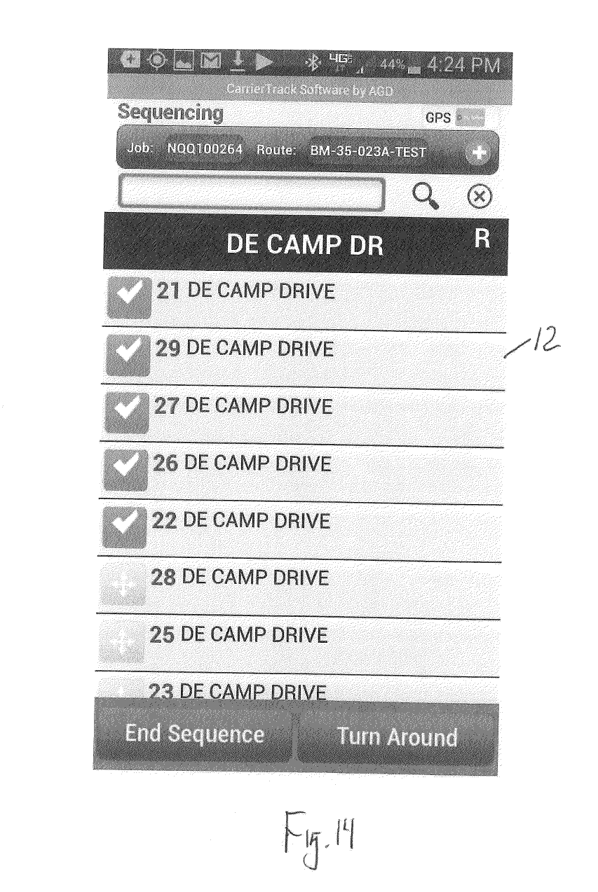

FIG. 15 is a screen shot of a device used with the methodology according to the present invention.

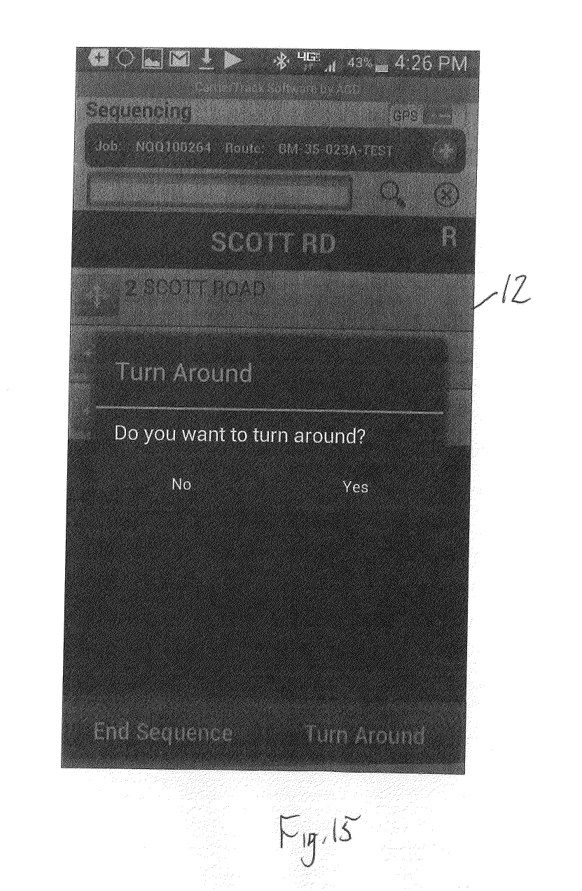

FIG. 16 is a screen shot of a device used with the methodology according to the present invention.

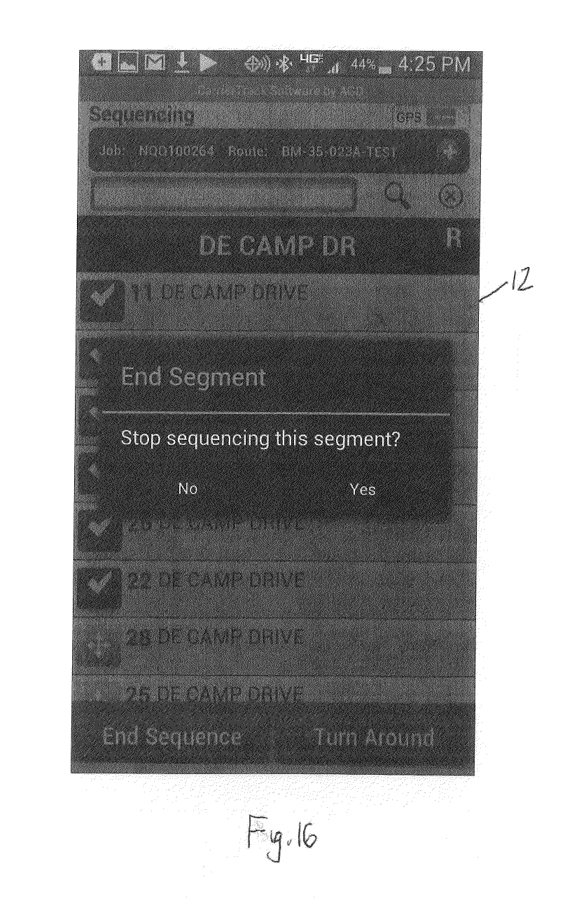

### DESCRIPTION OF THE EMBODIMENT(S)

Referring to die drawings, a method 10 and apparatus for use in delivering goods to a specific address is disclosed. The method and apparatus of the present invention comprises a side of street sequencing methodology 10 that allows for a driver and device 12 to sequentially mark addresses as delivered based on the addresses side of the street they are arranged on and the order in which the driver passes them while driving along the route sequence chosen by the driver. The methodology 10 may allow for geo coded addresses to be used to create a more efficient and reliable method of delivering periodicals, newspapers, magazines and/or other goods and services to predetermined residences, business locations or other locations required by subscribers of the goods and services. The method of delivering 10 of the present invention generally may be used in conjunction with any known tracking system that is capable of being incorporated into a larger database system that may efficiently provide goods and services to subscribers of periodicals, newspapers, magazines and/or other goods. The methodology and apparatus 10 of delivering to predetermined addresses relies on human interaction, via the driver, which allows for the driver to create the most convenient route for delivering the goods required to be delivered that day. The methodology 10 may let the driver determine the route to use to deliver the goods and/or services via the aid of the geo coded addressing which may be stored at a predetermined database or server at a remote location. The driver will not be forced to follow a route in any predetermined manner, and may determine on their own what is the most efficient way for the route to be delivered based on the goods being delivered on that particular day to the particular addresses in the particular areas as defined by the subscriber's subscriptions. The methodology 10 also allows for the driver or deliverer to manipulate the data once the route has been sequenced or delivered thus allowing for the manipulated data to be sent back to a remote location for further processing of the data by the business providing the goods to the predetermined address locations. This may also allow for real time verification of the deliveries to subscribers and customers via any web based, cloud based or server based verification system along with verification systems based on telephonic or any other communication device. Thus, any complaint of non or improper delivery may be resolved via verification provided by the methodology 10 herein. The methodology 10 can verify in a plurality of predetermined ways if the goods or packages have actually been delivered to the predetermined location requested by the subscriber of the delivered goods.

It should be noted that generally the method of delivering goods 10 of the present invention, which includes side of street sequencing allows for the driver of the vehicle to choose the delivery route that they will use that day via the use of the electronic device 12. Generally, the electronic device 12 may he any known tablet, laptop, smart phone, or any other electronic handheld device or a device that may be mounted to a vehicle being used for the delivery of such goods. Generally, these devices 12 may be capable of uploading and downloading information via either a Wi-Fi hotspot network, a home network or an over the air cellular network. This may allow for the device 12 to upload and download information between the remote location and the device 12 such as updating any of the latest delivery data needed for proper delivery of the goods 10 on the selected route. It should be noted that the device 12 may be capable of running, the methodology 10 on any known operating system or platform, such as but not limited to Android, Microsoft, Apple, etc. Furthermore, these devices also may be GPS capable thus allowing for the device 12 and methodology 10 to be used with bicycles and other human powered modes of transportation but still enabling the geo coded addresses to be sequenced according to the present methodology 10. It is also contemplated that the device 12 has the best battery charged life span possible to ensure all day use, is possible, is capable of having a car charger capability to be used with any type of car charging system and has a car mounting capability to allow for the most efficient use of the device 12 to ensure the most efficient delivery of the packages according to the present methodology 10. Generally, the remote locations to which the device 12 may be electronically connected may be a server or database located at the business providing the goods. This may allow for the delivery data to be integrated with the other data relating to the subscription particulars of the subscriber receiving the goods. This integration of die delivery data with the database or servers of the business providing the goods, etc., may also provide for real time confirmation to subscribers of delivery, any last minute changes to delivery schedules, any changes to the delivery address, etc., to be communicated directly to the driver delivering the goods in real time thus creating the most efficient and customer friendly delivery system of periodicals, newspapers, magazines and/or other goods. The present methodology and apparatus 10 may allow for a phone call by the subscriber to be made to the business and the business entering the information into the server and the server downloading the data to the device 12 in real time, thus allowing for last minute cancelations of subscriptions or delays of delivery of goods, or changes to where the goods should be delivered, or how the goods should be placed onto the residence or business or if further information is needed by the subscriber, etc. These changes may be directly sent to the device 12 in real time, thus allowing for last minute changes to the delivery needs of the subscriber.

It should further be noted that the methodology 10 of the present invention may have software or code that is capable of supporting the device 12 as described above. The device 12 may be able to upload and download information concerning delivery information from the business' servers to field deployed devices 12. The methodology 10 may be able to log and retain geo code validation of addresses when the device 12 is in a variable distance from a specific address. The methodology 10 may also be capable of listing addresses with various types of icons and instructions, such as do not deliver, etc. The methodology 10 may also be capable of storing data in at least two forms, however any other number of forms may he used, such as delivered to or do not deliver for a specific address in the sequence route. The methodology 10 may also be capable of having the same data on device 12, with just a different view of that data for specific delivery notes. The methodology 10 may also be able to when in proximity to an address that requires a photograph for verification of delivery, that the device 12 may alert the driver or user, such that the user may be able to click on the address to automatically launch a camera application or camera device wherein the user can add comments to the picture and that the photo may include a time stamp and actual latitude/longitudinal, geo data pulled from the GPS system upon which the unit device 12 is running. The methodology 10 may also be able to verify that the device 12 would, be used with any known verifier to confirm delivery by the drivers. The following processes may be needed to confirm, delivery, i.e., let the verifier or driver be able to download the information that contains all of the addresses on a route with instructions or in another embodiment let the verifier or driver search for an address in a route database, and when found, click to open the camera so that a picture may be taken and comment entered to verify delivery of the package. It should farther be noted that it is also contemplated that the methodology 10 may have route building capabilities that may let the driver build route patterns such that the information at a remote location, such as a server, may be organized and then, downloaded in delivery order upon subsequent downloads to that specific driver. The methodology 10 may also let a verifier or driver view all of the routes that have been completed over a map and if the devices 12 are signed In let the verifier view all of them over a comprehensive map. The methodology 10 may also allow the verifier to download a route in the same delivery order downloaded by a driver who has most recently driven the route. This may allow the verifier to see the route and the order that the driver ran the route. The methodology 10 may also let the device 12 notify the driver that they are approaching an address that is a do not deliver address, thus allowing for the driver to skip that address and increase the efficiency of the methodology 10. The methodology 10 may also be capable of capturing a GPS geo coding manually and have that contain an address for the purpose of correcting the geo code initially transmitted to the device 12 from the server from which, the street segment was downloaded from. This may allow for the driver to click on the address and indicate that this is the correct geo coding position for that address instead of the geo code position that was transmitted from the server. The methodology 10 may also let non-downloaded addresses be entered, photographed, commented on and/or stored to be uploaded to the server for further processing into the businesses subscription database.

The methodology of delivering packages 10 of the present invention comprises a methodology for sequencing and subsequently marking addresses as being delivered based on the addresses location, i.e., on which side of the street the building is located and the order in which the driver passes them while defining the sequence. The methodology 10 may allow for the driver to select the street segment 52 on the device 12 to which the driver wants to begin deliveries thereon. It should be noted that the street segment is part of an overall collection of segments, either adjacent or abutting one another, that is stored in a master database at the business side of the methodology 10. This may allow for a predetermined customer or subscriber database and their appropriate addresses to be stored in a central location and when each street segment needs to be retrieved in order to perform the delivery on that actual street, the driver may be capable of selecting a specific street segment and download such onto the device 12 for the subsequent delivery of the goods on the street segment. Once the street segment is downloaded to the device 12 in the vehicle with the driver, the driver may then select the sequence or segment mode for delivery. In one contemplated embodiment, the sequence mode shall be either the left side only of the street upon which the driver is on, the right side only of the street upon which the driver is on, or both sides of the street. Next, once the driver begins to drive down the selected street, the driver may be prompted to confirm the odd or even numbers of the houses to ensure the correct grouping of data has been selected for the street sequencing of the present invention. Once the confirmation has occurred, each of the geo coded addresses is passed and as it is passed it is sequenced, which means it is marked as being delivered by the methodology 10. It should be noted that if the driver turns onto a different street, the sequencing process must start again, i.e., a new street segment selection must be selected and downloaded, a new sequence mode must be chosen, and an odd and even address number confirmation must occur for the new street segment. Once the driver has finished sequencing the street segment route chosen, the driver may then use any known web based or any other interface to manually manipulate the data that was generated, on the device 12 in order to upload information back to the remote location with any changes to the delivery route observed by the driver. Based on this data created by driving and running the route, the methodology 10 may optionally, subsequently adjust the data via a web interface, such that the next time the route is run in delivery mode it may use the previous sequencing data to determine exactly which addresses to mark delivered, based on the sequence data which includes the side of the street on which the building is arranged.

The sequencing mode mentioned above allows for the sequence mode to be selected for either the left side only of the road upon which the vehicle is delivering, the right side only of the road or both sides of the road depending on the driver's selection. A proximity area 14 generally is defined by a predetermined distance to a side of the vehicle and a predetermined distance forward from the vehicle. In one contemplated embodiment, the distance forward from the vehicle is a variable distance forward (VDF), which may be calculated by calculating the miles per hour the vehicle is traveling times 5,280 and divide by sixty and divide that by four which may calculate the number of feet covered In fifteen seconds at the current speed. Then for the left side only and right side only sequence mode the proximity area 14 may extend a predetermined distance from the side of the vehicle. In one contemplated embodiment, this distance is approximately forty feet from the selected side plus or minus ninety degrees on the compass from the current heading. However, it should be noted that any other range or distance from three feet to a thousand feet may also be used for the selected side distance of the proximity area 14 of the methodology 10. The proximity area 14 is relative to the current GPS position and the current beading of the vehicle being driven by the driver. It should be noted that if both sides of the street is selected by the driver, then the side distance in one contemplated embodiment may be fifty feet to both the left side and right side of the vehicle, such that the proximity area 14 has a total side distance of one hundred feet and a variable distance forward or VDF as described above. The methodology 10 may monitor the proximity area 14 to determine the geo coded address to which the vehicle is approaching and pass on directions to the driver as to what should be delivered to the address, any special instructions or not to deliver to the address and once the proximity area 14 passes that address, that address may be sequenced or marked as delivered in a street sequencing for the street segment selected.

The methodology 10 may also prompt the driver to have the ability for the driver to determine if they want to turn around on the same route, thus affecting the sequencing. This turning around may also allow for the program to reconfirm that the addresses that are on the chosen side of the vehicle correspond to the addresses as shown in the methodology 10 downloaded from a remote location. It should be noted that the turn around function may or may not be part of the methodology 10 but may further be used to enhance the efficiency of the delivery of packages and goods according to the methodology 10 of the present invention. The ability to have the methodology 10 determine if the driver is turning around on a selected street segment may allow homes on the opposite side of the street to be delivered with seamless interaction by the methodology 10 as described herein.

The methodology 10 of the present invention may have a high level functionality map which includes boot services, which are always running on the device 12, which have an app blocker thereon and a breadcrumb recorder, which may allow for the route that has been traveled to be saved for future use. This high level functionality map may also include an application launch module that may download data from the server on initialization and activation of the software application used in the present methodology 10. The log in may ask for a local password cheek to verify the driver is indeed authorized to use the application. It should be noted that upon initial launch, the version may also be checked against the server and allow for a forced upgrade, if an upgrade of the software of the device 12 is needed. It should further be noted that the in application background processes, which generally are only running when the app is running, may include a data downloader that at a predetermined interval may download data from the server process SQlite statements and send a confirmation post back to the server. In one contemplated embodiment, this predetermined time frame occurs every ten minutes when the device is data connected. However, it should be noted that any other time frame may be used. Another background process running when the app is running is a data up loader, which in every predetermined time frame uploads delivery data, breadcrumbs, and headers for photos and/or binary photo files. This data up loader may run every five minutes when the device is data connected or any other interval depending on the design. The background process may also include a photo up loader, which may run every five minutes when data connected to upload photos to the server verifying delivery of packages. The app may also have a background process that runs a data cleanup module at a predetermined time interval.

It should he noted that the device 12 generally may have a home screen that may have the options of a deliver/verify, device status, change settings or manual sync. The deliver/verify function may display the list of routes and also allow for the driver to click on the route to enter the delivery mode. The device 12 status function may have a button that allows for the upload of the database, the upload data base function may post data base and error logs to the server in any known file format. The change settings function may allow for the language of the device 12 to be chosen from any known language and also to register the device 12, i.e., id with the server for provisioning and then also allow the device 12 to be entered into the administration mode to change the screen settings, etc. The final home screen function generally is a manual sync button which may allow for the user or driver to upload data manually instead of on a predetermined schedule, download data manually instead of on a predetermined schedule or check for an upgrade to the methodology 10 software.

After the device 12 enters a delivery mode and deliveries are occurring via the driver, at a predetermined interval the delivery mode may have background processes running. In one contemplated embodiment, these intervals occur every two to three seconds. However, it should be noted that any other time frame may be used. These delivery mode background processes may search the remote database for addresses on the route being used within a predetermined distance box from the current geo reading. In one contemplated embodiment, this is within a 0.25 or one quarter mile box from the current geo or GPS reading for the device 12. This may create a quick database result set that is larger than what is actually needed to process, but requires minimal work to retrieve. The background process may also parse the database results in code to see if any of the addresses should be marked as delivered and update the data accordingly. This parse function uses formulas to compare the vector, bearing and distance to figure out if the vehicle and driver has passed a predetermined geo coded address. The parse database results may also be used to see which addresses should be displayed on the screen and in what order. This display on the screen of the address also uses formulas to compare the vector, bearing and distance, such as those described above. The delivery mode background process also informs the breadcrumb service running in the background on the device 12 of the current route information so that the breadcrumbs are attributed to the route during the delivery thereon. This data is set when the route is started or ended and not reset every time the data refreshes. It should be noted that on the delivery screen as shown in the figures, there may also be buttons that allow for the job route description to be expanded to include additional route details such that if the driver clicks anywhere on an address it will pause the screen from updating and when paused the driver may then click on a photo icon to take a photo of the address and then approve and/or enter optional notes depending on the result of the photo taken. It should be noted that the methodology 10 may prompt and notify the driver that photo verification is required for a specific address. When paused, it should be noted that the driver may click on a tools icon on the screen to enter additional data about the address. Furthermore, it should be noted that each tool is a simple data entry form that only affects the currently selected address when the delivery mode process is paused. The above high level functionality map describes the general process being run by the methodology 10 on the device 12 of the present invention.

It should be noted that during the operation of the data processes the driver must have logged into the application software of the present invention, wherein the password may be stored locally and that the password must be entered once every twenty four hours and that the processes run regardless of whether the user is logged in and that no screens can be accessed in the app unless the user is logged in. The syncing of the device 12 with the server is a passive process that is generally attempted to run every fifteen minutes, however it should be noted that any other time frame may be chosen and that the syncing may be manually initiated from the device status screen. If there is no connection present a recorded failed attempt of the upload log table is recorded. The connection may be either via a radio connection, a Wi-Fi connection, cell connection or any other known connection. It should be noted that the methodology 10 may determine if the last successful attempt is more than fifteen minutes ago, then it may try to sync with the server at the present time. It should be noted that during the syncing process that the credentials may be verified via SSL and any uploading of data from LP or DP tables that have uploaded will be set as null. The methodology 10 may also allow for new routes from the server to be downloaded by the device 12 upon selection by the driver. It is also contemplated, that a cleanup data process may run which may select the routes to be cleaned, such as where the route verification date has passed or has been cancelled thus deleting the breadcrumbs and associated photos and address details from the database. It should be noted that the local screens/app tools on the device 12 may be passive tools that run continuously, such as a record breadcrumb update attempting to sync every fifteen minutes, checking for a GPS signal and alerting if the GPS signal radio is off or no signal is received and determining if a Wi-Fi network is available to the device. These may passively run continuously in the app. The breadcrumb may update every fifteen seconds, however it should be noted that any other time frame may be used for any of the passive apps used herein. The application may also have a status bar that may give the GPS signal quality, the radio signal quality, or if a route is running information to the user. The application may also include an interface or home screen, such as that described above. From the interface screen, the driver may select the delivery/verify addresses function. This function is where the driver may select the route from a route list table stored at a remote location. The route list table may be a predetermined table listing all of the subscribers in a subscription area and if they need to have a package or good delivered to them at a specific address. It may also include any details of the timing of the specific delivery and any special delivery notes, such as deliver at the door, in a mailbox, at any other location, etc. After the search route has been selected, the methodology 10 may show on the screen the delivered addresses and update the route list onto the screen. The address list may show either a do not deliver or a normal delivery mode and/or any special requests for the delivery. The device 12 may also show the remaining addresses to deliver to, thus alerting the driver which addresses still have to be delivered on the chosen route on the chosen street segment. The screen may also show which routes are not to be delivered to and also show the completed addresses, which show the addresses that had already had delivery completed thereon. The methodology 10 may update both the remaining and completed list in real time. The methodology 10 may passively mark the address as being delivered when the device 12 enters the delivery proximity area defined above. Thus, when the vehicle enters, with the device 12 therein, into the proximity area 14, defined in part by the current GPS position and current heading, the methodology 10 may mark that address as delivered or completed. Furthermore, during the current route list screen, there may be a photo function where each address on the list has a small camera icon and if the camera icon is clicked upon by the driver or deliverer it may open a camera on the device 12 or not on the device 12 and allow for the driver to take a photo, either approve/reject the photo and take again if necessary. If the photo is approved optional notes may be inputted and then the photo is stored and uploaded to the server at a remote location. There also are further icons for each address, which may allow for an update of the address information or an updated location of the house or business. There may also be a leave route function which may allow for the route list to be updated and allow an update of the last route activity for this route upon leaving the route. There also is a pause button which may allow for the driver to pause and stop the vehicle to enter notes about a specific address or to take care of other business before continuing the route processing.

It should be noted that many data tables are used in the software for the present methodology 10 of delivering goods to a specific address. Some of these data tables may have the following acronyms. D is a download only, no push back to server; DP is a downloaded data, modified locally and then, pushed back to server, L is local only, no data downloaded from the server and LP is local data, pushed to the server. Some, but not all, of the data definitions used in the methodology 10 are as follows: route list, which is a data table D; route list activity which is data table LP; street/summary list which is data table D; address detail list which is data table DP; photos, which is data table LP; breadcrumbs, which is data table LP; upload log which is data table LP; and log ins which is a data table LP. It should be noted that other data tables may also be used with the software and the interaction between the device 12 and the remote location, which generally is a server run by the business using the methodology 10 described herein.

In one contemplated embodiment, the methodology 10 is in the form of software, or any other type of code and associated algorithms, which may be used to control the device 12 and assist the driver in delivering goods or packages to predetermined addresses. One such, methodology, but not the only, for delivering to predetermined addresses initially may enter block 50 and initialize the program and prepare the program for use by the driver. In block 50, the driver may drive their vehicle to a first street segment to be delivered. The methodology 10 may then enter block 52, which is an entry mode and display on the device that the driver must select a street segment from the list. The driver may then select a street segment from a list, which has been downloaded from a remote location showing all of the street segments within a predetermined area around the location of the device 12 used by the driver in the vehicle. After the driver selects the predetermined street segment, the methodology 10 may enter block 54 and display on the device 12 that the driver must select a sequence segment mode from either left only, right only, or both sides of the street, which street segment was selected in the previous block. After the driver selects either the left side of the street, the right side of the street, or both sides of the street, the methodology 10 may then enter block 56 where the driver will confirm, that the house numbers are an odd or even number and on which side of the street the house numbers are arranged, thus verifying the data downloaded from the server to ensure proper delivery of the packages or goods to the appropriate address. After the driver confirms the house numbers, the side of the street, and the odd or even numbers of the addresses, the methodology 10 may enter block 58 where the driver may begin to drive down the route with the driver passing each next address in the sequence of the street segment selected by the driver. As the driver drives the route each address is sequenced as being delivered to once that address enters a proximity area 14 defined by the variable distance forward from the vehicle and a predetermined distance away from the side of the vehicle. The driver may then deliver each of the packages and verify, via photo verification, either by prompt or no prompt, or complete any other specific instructions for the delivery for each house. Next, the methodology may enter block 60 and determine if the driver is finished with the route sequencing for the entire street segment selected. If the driver is finished with the route sequencing for the street segment selected, the driver may then turn on to a new or the next street segment to be delivered and the methodology 10 returns to block 52 for further, processing. If in block 60 the driver is finished with the route sequencing and ail deliveries have been made which were assigned to the driver to deliver, the methodology 10 may enter block 62 where the driver will verify that they have finished their routes and they may then upload any information manually inputted into the delivery data captured by the driver, such as photo verification, change of address, location of houses, etc. Next the methodology may enter block 64, which is an edit mode, where the route for each day may be available for sequential editing via any known interface, such as a PC interface, a web based interface, or any other known interface. It should be noted that the display may be sequentially based on an uploaded order determined by the software described herein. After the route data is uploaded, the data uploaded from the driver, via the device 12 to the server located remotely at the place of business, the data may be analyzed and processed to further increase the efficiency of the route delivery system based on any changes to delivery requests by the customer directly to the driver or changes to the downloaded geo coded map based on driver verification and confirmation of addressees and street sides, etc.

It should be noted that the present invention generally has been designed for delivery of periodicals, newspapers, magazines and/or other goods. However, it may be used with any other delivery of any type of product, goods or services. It may also be used to verify map databases and the associated address and the side of the street upon which addresses appear on maps or other online content.

The present invention has been described in an illustrative manner. It is to be understood that the terminology, which has been used, is intended to be in the nature of words of description rather than that of limitation.

Many modifications and variations of the present invention are possible in light of the above teachings. Therefore, within the scope of the appended claims, the present invention may be practiced otherwise than as specifically described.

What is claimed is:

1. A method of delivering goods or packages by a driver on a route with a device, said method comprising the steps of:
selecting a predetermined street segment from a predetermined list;
selecting a segment mode;
delivering the packages to an address on the route;
marking said address as delivered based on a predefined proximity area;
determining if the driver is finished with a route sequencing; and
uploading delivery data to a remote location after said route sequencing is finished.

2. The method of claim 1 further comprising the step of driving to said street segment.

3. The method of claim 1 further comprising the step of confirming house numbers, side of street and/or odd or even number addresses.

4. The method of claim 1 further comprising the step of passing a next address in said route sequencing.

5. The method of claim 1 further comprising the step of moving to a new street segment for package delivery.

6. The method of claim 1 further comprising the step of editing grid route sequencing via a predetermined interface.

7. The method of claim 1 further comprising the step of displaying said predetermined street segment based on uploaded order thereof.

8. The method of claim 1 wherein said segment mode is either left side of said street segment, right side of said street segment or both sides of said street segment.

9. The method of claim 1 wherein said step of marking said address as delivered uses in part a variable distance forward of the device and a side distance from the device to calculate said proximity area.

10. The method of claim 1 wherein said address is a geo coded address.

11. The method of claim 1 further comprising the step of photographing the address to confirm delivery of the package.

12. The method of claim 1 further comprising the step of determining whether said address is a deliver to or do not deliver to.

13. The method of claim 11 wherein said photographing is completed with the device, the device having a camera integrated therein,

14. The method of claim 1 wherein said selecting a predetermined street segment step comprises downloading information from a remote location.

15. A method of sequencing geo coded addresses on a delivery route with use of a device, said method comprising the steps of:
a driver selecting a street segment on the device;
selecting a sequence mode for die delivery;
driving down said selected street segment;
confirming an odd or even number of the addresses; and
marking said address as delivered as it is passed by said driver.

16. The method of claim 15 further comprising the step of selecting another street segment if said driver moves onto a different street, and/or the step of determining if said driver is turning around on said street segment.

17. The method of claim 15 further comprising the step of manipulating data of said street segment by said driver with said device.

18. The method of claim 17 wherein said data is uploaded to a remote location for future use in delivery to said street segment at a later time.

19. The method of claim 15 further comprising the step of verifying delivery to said address by photo.

20. The method of claim 19 where said photo is time stamped and dated to confirm delivery.

21. The method of claim 15 wherein the device is GPS capable.

22. The method of claim 15 wherein said sequence mode is a left, right and/or both sides of said street segment.

23. The method of claim 22 where said sequence mode monitors a predetermined proximity area of said street segment.

24. The method of claim 15 wherein the device is either a laptop, tablet or smart phone.

25. The method of claim 18 wherein said remote location is either a server, computer, laptop, cloud or other electronic device.
